(19) United States
(12) Patent Application Publication
(10) Pub. No.: US 2026/0170263 A1
(43) Pub. Date: Jun. 18, 2026

(54) PROVIDING A USER INTERFACE TO IMPROVE RESPONSES FROM LARGE LANGUAGE MODELS BY UPDATING SESSION HISTORY OF A LARGE LANGUAGE MODEL

(71) Applicants: Constructor Technology AG, Schaffhausen (CH); Constructor Education and Research Genossenschaft, Schaffhausen (CH)

(72) Inventors: Sergey ULASEN, Singapore (SG); Alexander TORMASOV, Busingen am Hochrhein (DE); Serg BELL, Singapore (SG); Stanislav PROTASOV, Singapore (SG); Nikolay DOBROVOLSKIY, Alanya (TR); Laurent DEDENIS, Geneve (CH)

(21) Appl. No.: 18/983,451

(22) Filed: Dec. 17, 2024

(51) Int. Cl. G06F 40/40; G06F 3/0482; G06F 3/0484; G06F 40/166

(52) U.S. Cl. CPC G06F 40/40; G06F 3/0482; G06F 3/0484; G06F 40/166

(57) ABSTRACT

Disclosed herein are systems and methods for improving responses from LLMs by modifying chat history of at least one LLM. In one aspect, an exemplary method includes: obtaining a query; transmitting a prompt based on the query for input into a first LLM; obtaining a first response from the first LLM; displaying the query along with the first response from the first LLM; modifying a chat history of the first LLM based on obtaining a selection of at least one portion of the first response from the first LLM; combining the selected portions of the first response, the prompt, and the modified chat history into a new prompt for input into the second LLM; transmitting the new prompt for input into the second LLM; and obtaining and displaying a new response from the second LLM based on the new prompt.

### FIELD OF TECHNOLOGY

The present disclosure relates to the field of machine learning models (MLMs), and, more specifically, to systems and methods for providing a user interface for editing queries and improving responses from large language models (LLMs) by combining and editing responses from separate LLMs by editing a chat or session history of at least one LLM.

### BACKGROUND

Users may wish to harness the power of machine learning (ML) and utilize a MLM for a variety of tasks. In particular, LLMs may be used for a variety of tasks such as topic modeling, text classification, data cleansing, data labeling. In particular a LLM may understand and generate natural language text based on understanding prompts from a user. LLMs work by attempting to understand the prompt from the user and then outputting strings of words that the LLM predicts will best answer the prompt based on the data it was trained on. Generally, after a LLM generates a response to a query in a user interface (UI), the UI shows a new blank prompt for the user. Therefore, the user may forget what the prompt was and it is difficult to scroll back up to edit the query. In addition, since most LLMs have their own respective UIs, users cannot combine responses from different LLMs or easily input a query across multiple LLMs in a single UI. Therefore, there is a need for an improved user interface to combine and display results from multiple LLMs.

### SUMMARY

To address the shortcomings of displaying results from a LLM in a user interface, the present disclosure describes implementing a user interface that may improve and combine responses from different LLMs to create a new prompt. Some of the technical improvements of the present disclosure is the ability to eliminate multiple user interfaces for separate LLMs. In particular, the present disclosure provides a generic user interface that is configured to display the query and unify responses from different LLMs in a single UI. In addition, the present disclosure describes combining selected portions of responses from respective LLMs to generate a new query to improve response and to facilitate transmitting the new query across multiple LLMs within the single UI. Furthermore, the present disclosure generating prompts for annotating and editing the query and/or response to improve the original query by editing chat or session history of at least one LLM.

In one exemplary aspect, a method for providing a user interface (UI) to improve responses from large language models (LLMs) is disclosed, the method comprising: implementing a UI configured to combine and provide feedback from at least two LLMs by displaying responses from the at least two LLMs; obtaining a query from a user from an input portion of the UI; transmitting a prompt based on the query for input into a first LLM and a second LLM; obtaining at least a first response from the first LLM; displaying the query along with the first response from the first LLM in a first portion of the UI; modifying a chat history of the first LLM based on obtaining a selection of at least one portion of the first response from the first LLM; combining the selected portions of the first response from the first LLM, the prompt, and the modified chat history into a new prompt for input into the second LLM, wherein the first LLM is different from the second LLM; transmitting the new prompt for input into the second LLM; and obtaining and displaying a new response from the second LLM based on the new prompt in a second portion of the UI.

In some aspects, the techniques described herein relate to a method, wherein the combined portions of the first response are selected based on being modified, marked as important, not important, or to be deleted from the chat history.

In some aspects, the techniques described herein relate to a method, the method further comprising: transmitting the new prompt into the at least two or more LLMs; obtaining at least a first response from the first LLM and a second response from the second LLM; and displaying the query along with the first response from the first LLM in the first portion of the UI and the second response from the second LLM in the second portion of the UI.

In some aspects, the techniques described herein relate to a method, the method further comprising: combining parts of the first response from the first LLM and parts of the second response from the second LLM into a new query; transmitting the new query into one of the least two or more LLMs; and displaying the new query along with a third response from the one of the least two or more LLMs in a third portion of the UI.

In some aspects, the techniques described herein relate to a method, the method further comprising: displaying, in the UI, a supplemental UI comprising a menu of text editing functions for editing the query, the first response or the new response.

In some aspects, the techniques described herein relate to a method, the method further comprising: displaying, in the UI, a first graphical element configured to mark a response as important, not important, or to be deleted.

In some aspects, the techniques described herein relate to a method, the method further comprising: displaying, in the UI, a second graphical element configured to save at least one response.

In some aspects, the techniques described herein relate to a method, the method further comprising: displaying, in the UI, a drop down graphical element with options including at least: a first option to edit the query, a second option to save the query, a third option to mark a portion of the first response or the new response as important, a fourth option to mark a portion of the first response or the new response as unimportant, a fifth option to mark a portion of the first response or the new response as to be deleted, or a sixth option to edit the first response from the first LLM or the second response from the second LLM.

In some aspects, the techniques described herein relate to a method, the method further comprising: displaying a first metadata information corresponding to the first LLM and second metadata information corresponding to the second LLM in the UI.

In some aspects, the techniques described herein relate to a method, the method further comprising: obtaining a selection of at least a portion of the first response in the first portion of the UI for copying into an input area in the UI; inputting the selection of the at least a portion of the first response into the input area of the UI to transmitting as an updated query to the second LLM; transmitting the updated query for input into the second LLM; obtaining an updated second response from the second LLM; and displaying the updated query along with the updated second response from the second LLM in the second portion of the UI.

In another exemplary aspect, a method for improving responses from LLMs by modifying chat history of at least one LLM is disclosed, the method comprising: obtaining a query from a user; transmitting a prompt based on the query for input into a first LLM and a second LLM; obtaining at least a first response from the first LLM; modifying a chat history of the first LLM based on obtaining a selection of at least one portion of the first response from the first LLM; combining the selected portions of the first response from the first LLM, the prompt, and the modified chat history into a new prompt for input into the second LLM, wherein the first LLM is different from the second LLM; transmitting the new prompt for input into the second LLM; and obtaining and displaying a new response from the second LLM based on the new prompt.

In some aspects, the techniques described herein relate to a method, the method further comprising: transmitting a request to an application programming interface (API) for the first LLM with the query, wherein the API processes the query by routing the query to the first LLM for processing the query and generating the first response; obtaining the first response of the first LLM for display in the first portion of the UI; transmitting a request to an API for the second LLM with the query, wherein the API processes the query by routing the query to the second LLM for processing the query and generating a second response; and obtaining the second response of the second LLM for display in the second portion of the UI.

According to one aspect of the disclosure, a system is provided for providing a user interface (UI) to provide a user interface (UI) to improve responses from large language models (LLMs) by modifying chat history of at least one LLM, the system comprising at least one memory; and at least one hardware processor coupled with the at least one memory and configured, individually or in combination to: implement a UI configured to combine and provide feedback from at least two LLMs by displaying responses from the at least two LLMs; obtain a query from a user from an input portion of the UI; transmit a prompt based on the query for input into a first LLM and a second LLM; obtain at least a first response from the first LLM; cause, on a display, a display of the query along with the first response from the first LLM in a first portion of the UI; modify a chat history of the first LLM based on obtaining a selection of at least one portion of the first response from the first LLM; combine the selected portions of the first response from the first LLM, the prompt, and the modified chat history into a new prompt for input into the second LLM, wherein the first LLM is different from the second LLM; transmit the new prompt for input into the second LLM; and obtain and cause, on the display, a display of a new response from the second LLM based on the new prompt in a second portion of the UI.

In one exemplary aspect, a non-transitory computer-readable medium is provided storing a set of instructions thereon for providing a user interface (UI) to improve responses from large language models (LLMs) by modifying chat history of at least one LLM, wherein the set of instructions comprises instructions for: implementing a UI configured to combine and provide feedback from at least two LLMs by displaying responses from the at least two LLMs; obtaining a query from a user from an input portion of the UI; transmitting a prompt based on the query for input into a first LLM and a second LLM; obtaining at least a first response from the first LLM; displaying the query along with the first response from the first LLM in a first portion of the UI; modifying a chat history of the first LLM based on obtaining a selection of at least one portion of the first response from the first LLM; combining the selected portions of the first response from the first LLM, the prompt, and the modified chat history into a new prompt for input into the second LLM, wherein the first LLM is different from the second LLM; transmitting the new prompt for input into the second LLM; and obtaining and displaying a new response from the second LLM based on the new prompt in a second portion of the UI.

The above simplified summary of example aspects serves to provide a basic understanding of the present disclosure. This summary is not an extensive overview of all contemplated aspects, and is intended to neither identify key or critical elements of all aspects nor delineate the scope of any or all aspects of the present disclosure. Its sole purpose is to present one or more aspects in a simplified form as a prelude to the more detailed description of the disclosure that follows. To the accomplishment of the foregoing, the one or more aspects of the present disclosure include the features described and exemplarily pointed out in the claims.

### BRIEF DESCRIPTION OF THE DRAWINGS

The accompanying drawings, which are incorporated into and constitute a part of this specification, illustrate one or more example aspects of the present disclosure and, together with the detailed description, serve to explain their principles and implementations.

FIG. 1 is a block diagram illustrating a system for providing a user interface (UI) to improve responses from large language models (LLMs) according to aspects of the present disclosure.

FIGS. 2A-2E are diagrams illustrating a method for combining selected portions of an response from a first LLM to generate a new query for input into a different LLM according to aspects of the present disclosure.

FIGS. 3A-3B are diagrams illustrating a method for combining responses from two responses of LLMs to generate a new query for a third LLM according to aspects of the present disclosure.

FIG. 4 is a diagram for modifying a chat/session history of at least one LLM in order to improve responses according to an aspect of the present disclosure.

FIG. 5 is an example method for improving a response of a LLM based on editing chat history using a single LLM according to an aspect of the present disclosure.

FIG. 6 is an example method for improving a response of LLMs based on feedback from a user using multiple LLMs according to an aspect of the present disclosure.

FIG. 7 presents an example of a general-purpose computer system on which aspects of the present disclosure can be implemented.

Like reference numbers and designations in the various drawings indicate like elements.

### DETAILED DESCRIPTION

Exemplary aspects are described herein in the context of a system, method, and computer program product for providing a user interface (UI) to improve responses from MLMs. Those of ordinary skill in the art will realize that the following description is illustrative only and is not intended to be in any way limiting. Other aspects will readily suggest themselves to those skilled in the art having the benefit of this disclosure. Reference will now be made in detail to implementations of the example aspects as illustrated in the accompanying drawings. The same reference indicators will be used to the extent possible throughout the drawings and the following description to refer to the same or like items.

Different LLMs may provide different responses to a same prompt due to a complex interplay of factors, including training data, model architecture, training objectives, inference techniques, preprocessing steps, and prompt design. First, different MLMs are trained on different datasets, which can vary in size, diversity, and quality. For example, a particular model may be trained on a dataset that includes more scientific literature, while another might have more conversational data. In addition, training data may introduce biases that affect a particular model's responses. As an example, if a model's dataset has more examples of a particular type of language or viewpoint, then that difference will be reflected in its response. Second, different MLMs may have different architectures. For example, GPT-3 and BERT are both transformer-based models but are designed for different tasks and have different internal structures. Third, training objectives between the MLMs may be different. For example, some models may be fine-tuned for specific tasks, such as question answering, summarization, or translation. Fourth the different MLMs may have different inference techniques. As a non-limiting example, the methods used to generate text during inference may vary such that different strategies can produce different responses even from the same model. Parameters like temperature and top-k sampling can also affect randomness and creativity of the generated text.

Accordingly, users are often forced to choose between using a single LLM at a time since each LLM generally has their own interface and/or application for the user to interact with the LLM. Some platforms provide web-based interfaces where users may directly interact with LLMS by typing in prompts and receiving responses. Application Programing Interfaces (APIs) may also allow developers to integrate LLM capabilities into their own applications.

In addition, a chat or session history of a LLM plays a significant role in shaping any subsequent responses from the LLM. The idea is that by providing context from previous interactions with a user, the chat history helps maintain continuity, relevance, and coherence throughout a conversation with the LLM. Accordingly, since LLMs do not have memory, the chat history serves as basis for each subsequent query. For instance, LLMs use the prior parts of the conversation to understand the context of a user's current or subsequent query. Without using chat history, each query would be treated in isolation, leading to disjointed or irrelevant responses.

Some LLM systems (especially those with memory features) can remember preferences or specific details from previous interactions, personalizing the responses to align with user interests or past requests. This creates a more tailored experience, where the model may adjust to a user's preferred style of interaction or topics of interest. Accordingly, users may ask follow-up questions (or make clarification) based on previous responses. With session/chat history, the LLM model can respond appropriately, acknowledging prior answers and/or instructions. In this way, the LLM models may provide more accurate, nuanced, and personalized answers based on what has already been discussed and selected by the user as important, not important, or deleted to provide an additional data point and address complex, multi-turn queries more effectively.

The present disclosure describes various aspects of improving responses from multiple LLMs by editing chat/session history of at least one LLM. One aspect involves creating a new prompt for input into a second LLM based on combining edited chat history or selected portions of an response from a first LLM.

A second aspect involves editing a chat and/or session history of a LLM by marking portions of a response from the LLM as important, not important, or to be deleted from the chat and/or session history altogether. For example, a user may review responses from a first LLM and realize that some portions of the response are more relevant than others (e.g., that the responses are beginning to get offtrack), the user may edit the chat/session history such that any subsequent responses from the first LLM or prompts generated based on the responses from the first LLM will include a modified chat/session history to personalize the responses to align with the user's requests or expectations.

A third aspect involves transmitting a query from a user into multiple LLMs and displaying the query along with the responses from each respective LLM in a single UI. For example, a user may easily switch between windows, copy and paste queries or responses between different LLMs and combining the responses to another LLM in the same UI.

A fourth aspect involves a user interface displaying a query along with responses from multiple LLMs and a drop down graphical element with options to at least edit the query, save the query, or mark the query as important, unimportant, or neutral. For example, the LLM response is accompanied by a new UI element (e.g., such as a dropdown menu) that allows the user to edit the response in order to improve the original query in a single UI.

Turning now to the figures, example aspects are depicted with reference to one or more components described herein, where components in dashed lines may be optional.

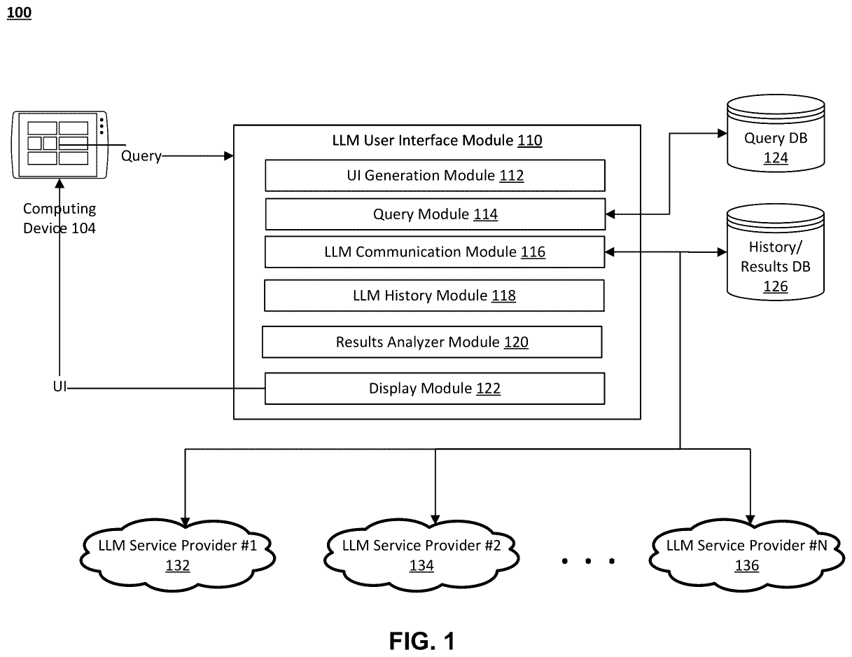

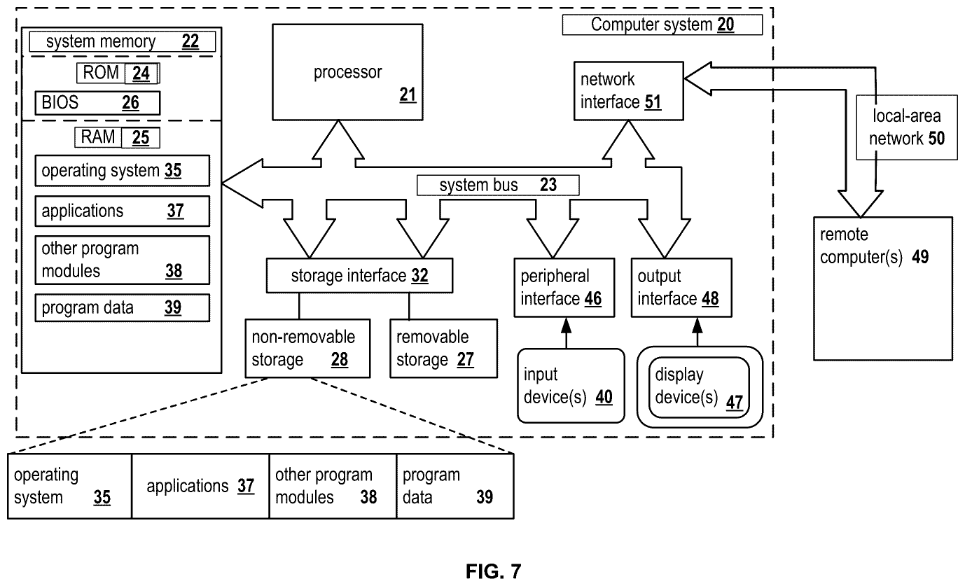

FIG. 1 is a block diagram illustrating a system 100 configured to provide a UI to improve responses from different LLMs. In one aspect, the components of system 100 may be implemented on computer systems, such as that shown in FIG. 7.

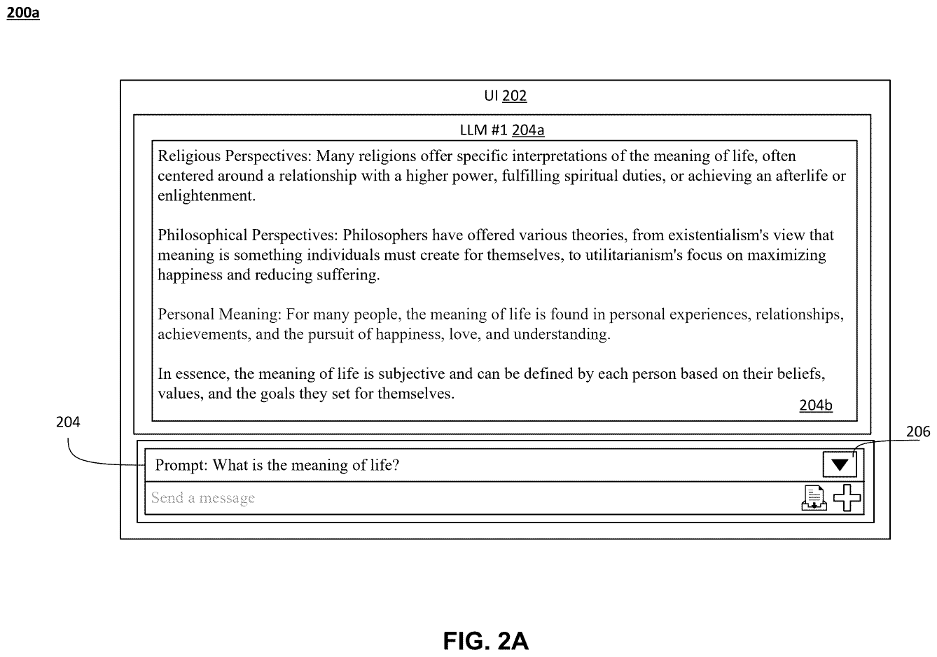

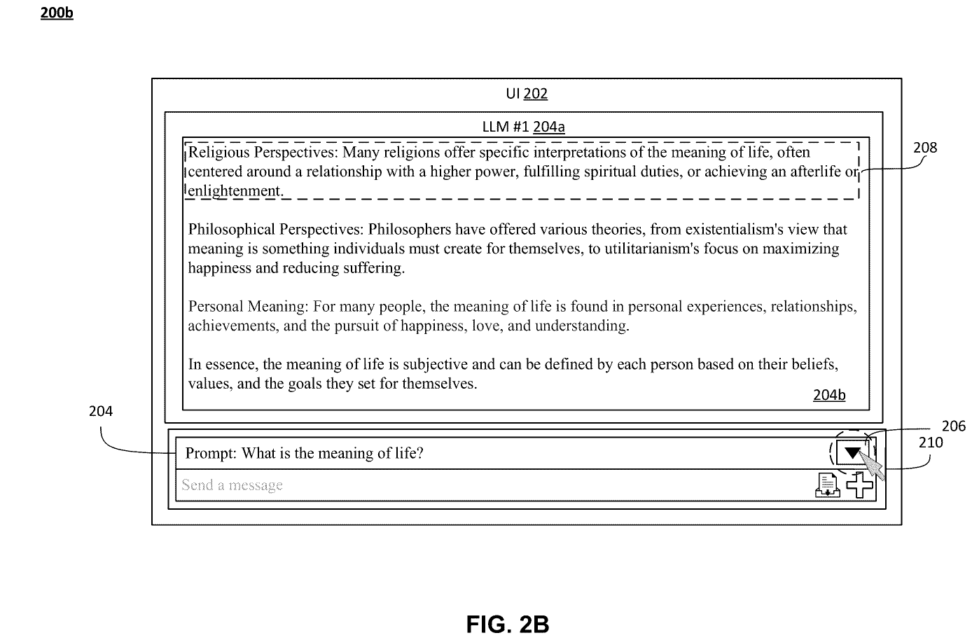

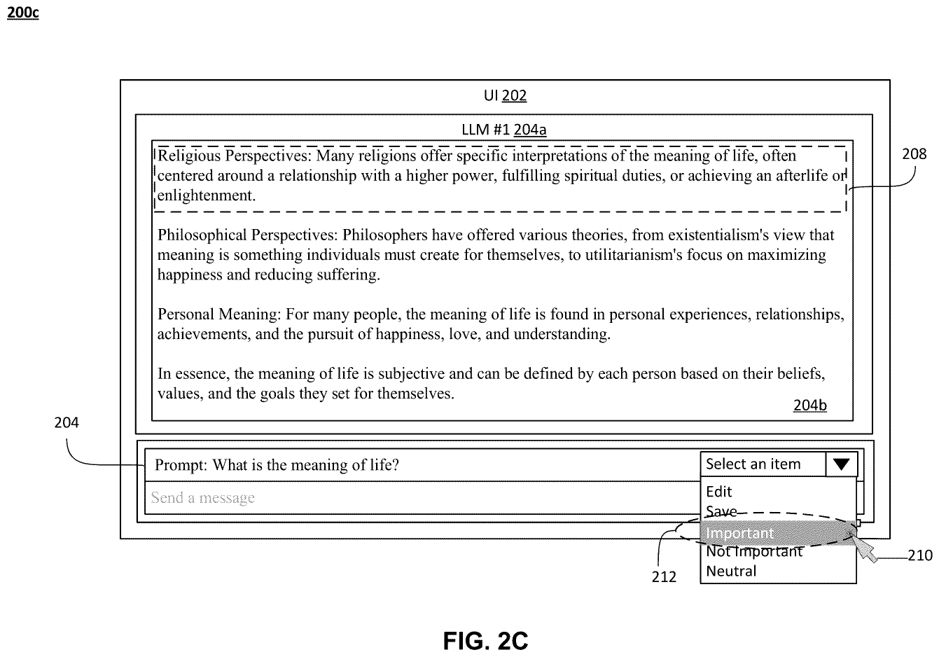

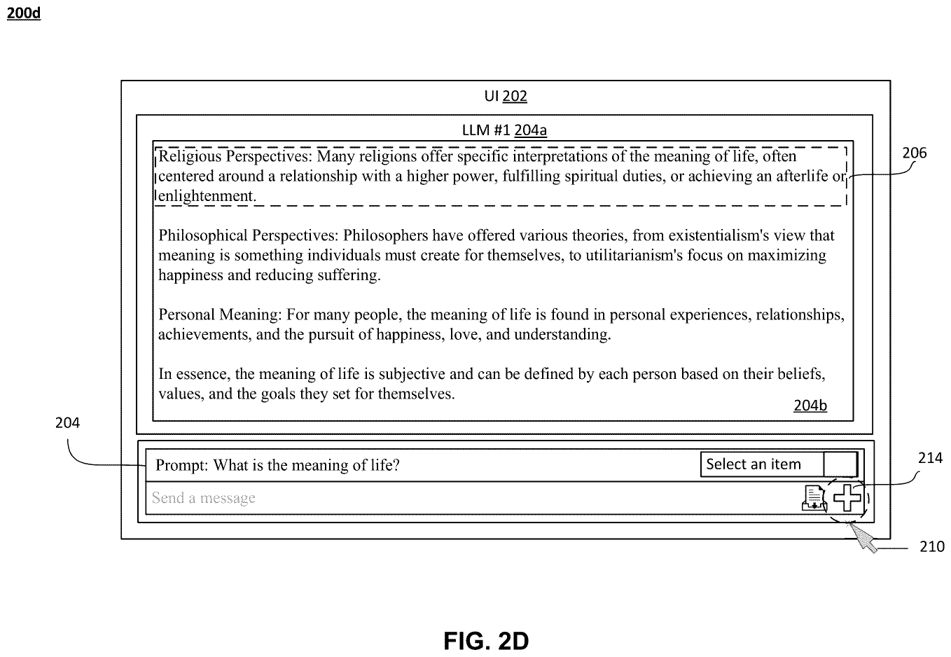

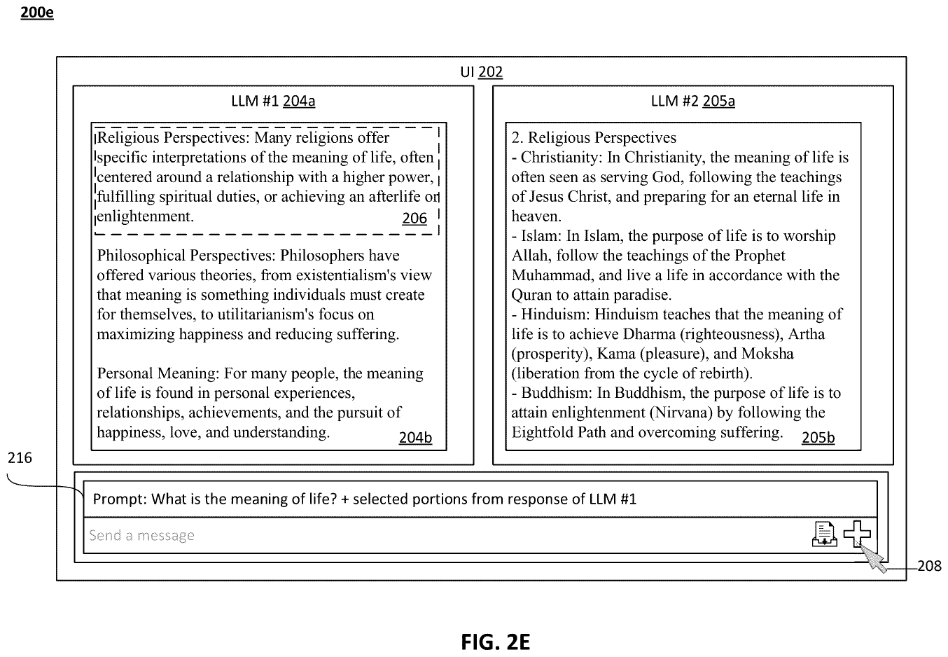

The system 100 may be used to generate and implement a UI for display on the computing device 104. Generally, the LLM UI module 110 is configured to generate a single UI (which will be described in more detail in FIGS. 2A-2E, 3A-3B, 4, and 5) that facilitates transmitting a prompt across the different LLM service providers 132, 134, 136 and unifies responses from the different LLM service providers 132, 134, 136 in a single UI that is displayed on a display of the computing device 104. This provides a way for a user to collect responses from different LLMs, edit chat/session history from at least one LLM, and combine responses to generate a new prompt to improve the original query. In particular, the single UI) may display at least the original query from the user, at least one response from LLMs corresponding to the LLM service providers 132, 134, 136, and new UI elements (e.g., drag down menus, UI graphical elements) that allow users to edit or annotate the query and/or response to improve the original query.

In one aspect, the system 100 includes at least a computing device 104, a plurality of LLM service providers 132, 134, 136 each connected to a respective LLM model and a LLM UI module 110. Users of the computing device 104 may communicate with the LLM service providers 132, 134, 136 via the LLM UI module 110. Notably, the LLM of the present embodiment may be implemented on a cloud server, local server, or local devices. As an example, the LLM UI module 110 may be hosted on a cloud server or allocated at a local device.

Each LLM service providers 132, 134, 136 may each connect to a different LLM that generates a different response using an exact same prompt. These LLM models each use machine learning to understand, process, and generate natural language text in response a query from a user. The LLM models are responsible for the “intelligent” behavior of an application such as answering questions, creating content, summarizing information, translating text, or the like. Accordingly, it is to a user's advantage to view multiple responses from different LLM service providers 132, 134, 136 rather than to rely on just one response from a single LLM service provider. It is noted that the system 100 includes any number of LLM service providers and FIG. 1 only shows the components relevant for the illustrative example of the present disclosure.

In some aspects, the system 100 may include a LLM UI module 110 configured to process a query from a computing device 104 from a user and generate and transmit a prompt based on the query into different LLM service providers 132, 134, 136. In this way, the computing device 104 may be configured to display a single UI with the query and responses from the LLM service providers 132, 134, 136. The computing device 104 may execute a plurality of modules in the LLM UI module 110 that together make up at least an interface to interact with different LLM service providers. The LLM UI module 110 may include at least the following functional modules: a UI generation module 112, a query module 114, a LLM communication module 116, a LLM history module 118, a results analyzer module 120, and a display module 122. Some of these functional modules may be deployed locally on servers, hosted on remote servers, or on local devices.

In some aspects, the LLM UI module 110 may be allocated directly on the computing device 104. In some aspects, the LLM UI module 110 may be hosted on a cloud server. Specifically, the portions of the LLM UI module 110 may be hosted or allocated on different devices. For example, the LLM communication module 116 may be hosted on a cloud system and the results analyzer module 12—and display module 122 may be hosted on a local device.

The computing device 104 may execute a UI generation module 112 to implement a UI for display on the computing device 104 that is configured to receive input from the computing device 104 and combine and provide feedback from at least one of the LLM service providers 132, 134, 136. In some aspects, the UI generation module 112 generates a single UI (as will described in more detail in FIGS. 2A-2E, 3, and 4) and layout and components of the UI elements (e.g., menus, buttons, forms, grids, etc.) based on predefined rules, data models, or templates. In some aspects, the UI generation module 112 may also be configured to automatically adjust the UI elements based on the content or data that it needs to display such as adapting a form to input fields or displaying a list of items. In some aspects, the UI generation module 112 may also be configured to adapt the UI to different screen sizes and resolutions by making sure that the UI works well across various devices.

In some aspects, the user interface may be implemented as web-based interface or a desktop application. The user interface allows users to use text queries, prompts, and/or upload files to query LLM service providers 132, 134, 136 for answers to specific questions, to perform particular tasks, or, depending on the natural language processing capabilities of the LLM, to simulate a conversation with the LLM service providers 132, 134, 136 on topics related to the query, prompt, or uploaded files on which the LLM service providers has been trained to answer.

The computing device 104 may also execute a query module 114 to obtain a query from a computing device 104 of a user. Generally, the query module 114 is configured to act as an intermediary layer in LLM-based systems by enhancing a LLM model's ability to understand, interpret, and respond to user queries effectively. Specifically, the query module 114 may be configured to handle and interpret user queries and generate a prompt from the query that is formatted in a way that a LLM from the LLM service providers 132, 134, 136 may process effectively. The primary role of the query module 114 is to bridge the gap between raw user input from the computing device 104 and at least one of the underlying LLM service providers 132, 134, 136. In some aspects, the query module 114 may be equipped with natural language understanding for analyzing and interpreting the query to understand its intent, context, and meaning. This may involve recognizing entities, key phrases, intents, and relationships within the query.

As an example, a user may use the computing device 104 to enter a query for input as a prompt into at least one LLM service provider 132, 134, 136. In some aspects, the query module 114 may prepare the query as a prompt for input into at least one LLM service provider 132, 134, 136 by cleaning and normalizing the text. As an non-limiting example, this may involve: removing unnecessary punctuations, special characters, or stop words; correcting spelling or grammatical errors; or converting different forms of data (e.g., dates, numbers, or units) into a standardized format. By identifying the user's intent behind the query (e.g., asking a question, requesting information, or performing a task), the query module 114 ensure that an appropriate LLM service provider may determine the appropriate type of response or action.

In some aspects, the query module 114 is connected to a query database 124 for storing past queries. For example, the query module 114 may maintain and manage the context of ongoing interactions. In this way, the LLM can understand and respond correctly in multi-turn conversations by retaining information from previous exchanges. In addition, the user may go back and edit the original query easier in the future. In addition, the query database 124 collects and stores feedback on the quality of responses and incorporates this data to refine future query handling, which allows the system to learn and adapt based on user interactions. In some aspects, by recalling a user's query history from the query database 124, the query module 114 may also adjust responses based on user preferences, history, or context. This may involve using a personalized tone, referencing previous interactions, or adapting content to suit the user's knowledge level or interests.

In some aspects, the query module 114 may reformulate and restructure queries to enhance their clarity and ensure that they align with the strengths and weaknesses of particular LLM service providers. This may include simplifying complex sentences or breaking down multi-part questions. In this way, the query module 114 may enhance an LLM service provider's ability to understand and respond accurately to user queries by optimizing and clarifying input.

The computing device 104 may execute a LLM communication module 116 configured to interact with at least one of the LLM service providers 132, 134, 136 by transmitting a prompt generated by the query module 114 for input into at least one of the LLM service providers 132, 134, 136 and to obtain responses from each respective LLM service provider. Generally, the LLM communication module 116 is responsible for managing the interactions between the LLM service providers 132, 134, 136 and modules from the LLM UI module 110. The primary function of the LLM communication module 116 is to handle the exchange of data between the LLM UI module 110 and the LLM service providers 132, 134, 136 to ensure that the inputs and output of the LLM are effectively communicated to the appropriate destinations. This module serves as the interface layer that facilitates communication to enable the LLM service providers 132, 134, 136 to integrate into the system 100.

In some aspects, the LLM communication module 116 is configured to provide an application programming interface (API) that the LLM UI module 110 utilizes to interact with the LLM service providers 132, 134, 136. As a non-limiting example, this may include handling API requests and responses from the LLM service providers 132, 134, 136, managing authentication and authorization for secure access, or supporting different API protocols (e.g., REST, WebSocket) to accommodate various integration needs.

In some aspects, the LLM communication module 116 may be configured to keep track of active sessions with users or applications to maintain continuity in multi-turn conversations. This may involve storing session-specific data such as context, chat or session history, or state information or managing multiple concurrent sessions to ensure that each session receives the correct context and responses.

In some aspects, the LLM communication module 116 may be configured to integrate with external systems and databases such as a history/results database 126 or a query database 124. This may involve fetching additional data needed to answer a query or enabling bidirectional communication between the LLM service providers 132, 134, 136 and external systems (e.g., CRM software, knowledge bases, or real-time data feeds). In some aspects, the LLM communication module 116 may collect and manage data related to user preferences or behavior to deliver personalized responses by accessing the history/results database 126.

The computing device 104 may execute a LLM history module 118 configured to modify a chat history of at least one LLM. This allows the LLM history module 118 to modify or rewrite parts of the chat history based on updated information or user input to retroactively adjust context if the user corrects a misunderstanding or provides new, overriding information. For example, a user may view a response from a LLM and select at least one of the portions of the LLM as important, unimportant, to be deleted, or edit the response from the LLM in order to modify the chat history of the LLM. In some aspects, the LLM history module 118 is also configured to store and/or access chat/session history of a respective LLM from the history/results database 126. In this way, the LLM history module 118 allows the LLM system to edit or forget certain parts of the chat history. This can be useful when a user wants to pivot to a new topic or further clarify a response without the previous context affecting future responses. In some aspects, the LLM history module 118 may be configured to highlight or mark important parts of the chat for the model to emphasize in future responses. This ensures that key elements of the conversation get more attention from the model (or other LLM models) in subsequent interactions, improving the relevance of responses. In addition, this may also balance how much influence various parts of the history have in future prompts. For example, more recent interactions might be given more weight, while older context is less prioritized but still available. Finally, the LLM history module 118 helps facilitate multi-session continuity to carry over key parts of the chat history across different sessions and different LM models. These functions all work together to make the interaction with the LLM (or other LLMs) more flexible, personalized, and contextually relevant.

The computing device 104 may execute a results analyzer module 120 configured to combine selected portions of responses from LLMS and/or include modified chat/session history from LLMs into new prompts for input into the LLM service providers 132, 134, 136 by sending-LLM generated outputs to other applications, LLM service providers, or workflows. Generally, the results analyzer module 120 is responsible for evaluating, refining, and post-processing the outputs generated by the LLMs from the LLM service providers 132, 134, 136. In other words, the results analyzer module 120 ensures that the results produced by the LLMs from the LLM service providers 132, 134, 136 are accurate, relevant, coherent, and aligned with the user's needs.

In some aspects, the results analyzer module 12—is configured to assess the quality of the generated output based on predefined criteria, such as relevant, accuracy, fluency, grammatical correctness, and coherence. In some aspects, the results analyzer module 12—may be configured to check whether the generated responses is relevant to the user's query or the task at hand. In some aspects, the results analyzer module 120 may filter out or flag irrelevant, off-topic, or nonsensical outputs. In some aspects, the user may use the UI to mark portions of the responses from the LLM models as important, not important, or neutral. These marked portions may be stored in the history/results database 126.

The computing device 104 may execute a display module 122. The display module 122 may be configured to generate and display the query from the user and at least one response from a LLM service provider. Generally, the display module is responsible for managing and rendering the visual components of the user interface by handling the presentation of information to the user, ensuring that data and controls are displayed correctly and consistently across the UI.

In some aspects, the display module 122 is configured to render or draw all the elements of the UI, such as windows, buttons, text fields, menus, icons, images, and other components. In some aspects, the display module 122 is configured out update the UI when the data changes or user interactions occur (e.g., clicking a button or typing in a text box) such that the display module updates the UI accordingly. This could mean refreshing a portion of the screen, changing the state of a button, or displaying new data. In other words, the display module 122 may be considered the “view” part of a model-view-controller (MVC) or similar design pattern. It serves as the layer that presents data to the user and receives input to and from the computing device 104.

FIGS. 2A-2E are diagrams illustrating a method for combining selected portions of an response from a first LLM to generate a new query for input into a different LLM according to aspects of the present disclosure. Examples 200a-200e illustrate how responses from an initial LLM model based on a user prompt may be used to generate a new prompt for input into a different LLM model to improve responses.

As shown in example 200a, the UI 202 displays at least a response 204b from a first LLM 204a via a LLM service provider based on a query, the prompt 204, and a drag down menu 206 configured to perform different editing or annotation functions of the query and/or response from the query.

As shown in example 200b, after reviewing the response 204b from the first LLM 204a, the user may highlight a relevant portion 208 of the response 204b from the LLM 204a as important or noteworthy. For example, the relevant portion 208 of the response 204b may be of particular interest or relevant to the user such that the user may improve the response by generating a new prompt to enter into either the same LLM or a different LLM based on the relevant portion 208 of the response.

In an aspect, after highlighting the relevant portion 208 of the response 204b from the first LLM 204a, the user may use a mouse cursor 210 (or any other suitable input mechanism such as a touch screen) to select the drag down menu 206.

As shown in example 200c, the user uses the drag down menu 206 to select menu items such as editing the query, saving the query, and marking selected portions of the response as important, unimportant, or neutral. Here, the user has selected the relevant portion 208 of the response 204b from the first LLM 204a and would like to mark this portion as important 212.

As shown in example 200d, the user uses a cursor 210 to generate a new prompt based on the relevant portion 208 of the response 204b from the first LLM 204a by selecting a graphical element 214 configured to mark a response as important.

In response to the user generating the new prompt based on the relevant portion 208 of the response 204b from the first LLM 204a, a new prompt is generated and transmitted to a second LLM. As shown in example 200e, the new response 205b generated by the second LLM 205a is displayed in the same UI 202 as the response 204b generated by the first LLM 204a as well as the newly generated prompt 216.

In this way, the user is presented with improved responses to their original query by easily generating new prompts based on queries and/or responses from a first LLM. The user may also edit and annotate by editing prompts and/or responses as to keep, to change, as important, as unimportant, or neutral. It should be noted that the new prompt may be input back into the first LLM or into a different LLM. Furthermore, the UI is configured to combine the responses from both the first LLM with the original query and the response from either the first LLM or different LLM with the new prompt in a single UI as well as the actual new prompt.

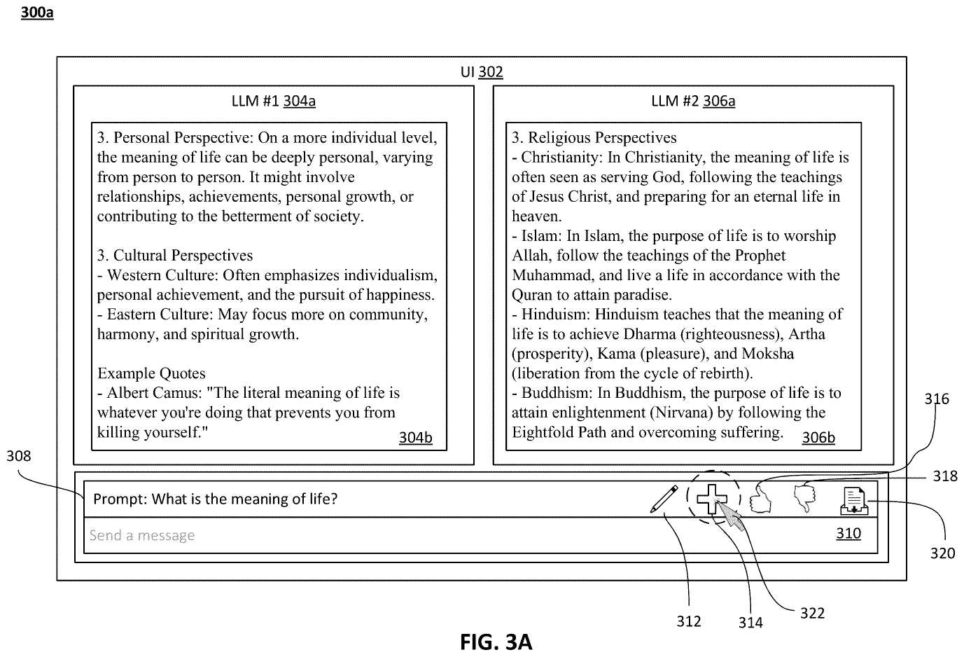

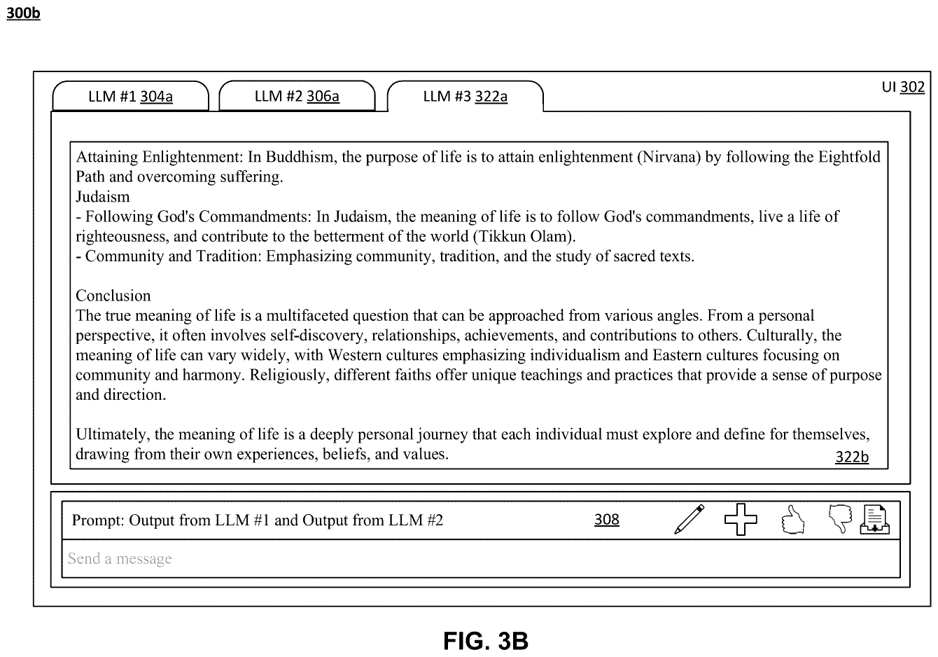

FIGS. 3A-3B are diagrams illustrating a method for combining responses from two responses of a first and second LLMs to generate a new query for a third LLM according to aspects of the present disclosure.

As shown in example 300a, the UI 302 displays a first response 304b from a first LLM 304a concurrently with a second response 306b from a second LLM 306a generated from a user prompt 308 of “what is the meaning of life” that is also displayed in the UI 302 and an input portion 310 to generate a new query. It should be noted that the prompt 308 portion of the UI 302 includes graphical elements including at least a first graphical element for editing the query and/or response 312, a second graphical element for generating a new prompt 314, a third graphical element for marking the query and/or response as important 3, a fourth graphical element for making the query and/or response as unimportant 316, and a fifth graphical element for saving the query and/or response 318.

In response to the user selecting the second graphical element for generating a new prompt 314 using a cursor 322, the new prompt is transmitted and input into a third LLM. As shown in example 300b, the UI 302 displays a response 322b from a third LLM 322a based on the new prompt along with a display of the new prompt 308.

It should be noted that in example 300b, the response 322b from the third LLM 322a is shown as a separate tab of the UI 302 for illustrative purposes only. In some aspects, the response 322b from the third LLM 322a may be shown in conjunction with the responses from the first LLM 304a and the second LLM 306a.

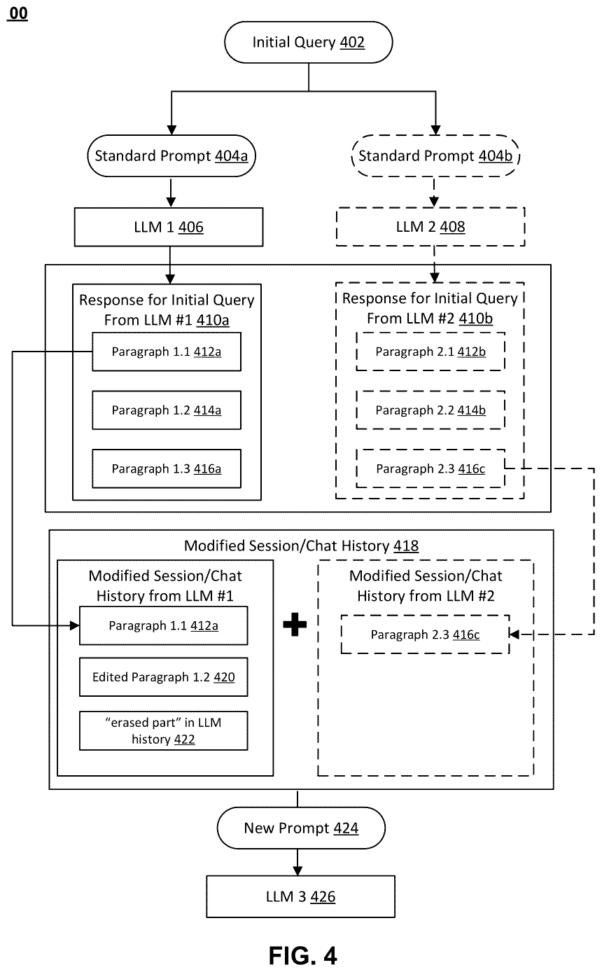

FIG. 4 is a diagram for modifying a chat/session history of at least one LLM in order to improve responses according to an aspect of the present disclosure. In various implementations, the method 400 is performed by a device with one or more processors and non-transitory memory that performs intent prediction. In some implementations, the method 400 is performed by processing logic, including hardware, firmware, software, or a combination thereof. In some implementations, the method 400 is performed by a processor executing code stored in a non-transitory computer-readable medium (e.g., a memory). The method 400 describes a method for editing a session/chat history of at least one LLM in order to generate a new prompt to personalize subsequent responses.

The method 400 begins with obtaining an initial query 402 to generate a standard prompt 404a for a first LLM 406, optionally, a standard prompt 404b for a second LLM 408.

The method 400 then obtaining a response from the initial query 410a from the first LLM 406. The response from the initial query 410a from the first LLM 406 may be made up of a first paragraph 1.1 412a, a second paragraph 414a, and a third paragraph 416a. In some aspects, a user may then select a portion of a first response (e.g., paragraph 1.1 512a) from the first LLM as important after reviewing the response. As an example, referring back to FIGS. 2A-2E, a user may select the “religions perspective” 208 as particularly important.

Optionally, the method 400 may also include generating a standard prompt 404b for input into the second LLM 408 to obtain a response for the initial query 410b from the second LLM 408. The response from the initial query 410b from the second LLM 408 may include a first paragraph 2.1 412b, a second paragraph 2.2 414b, and a third paragraph 2.3 416c. Here, a user may also select a portion of a first response (e.g., paragraph 2.1 512b) from the second LLM as important.

The method 400 may then include modifying a session/chat history 418 of the first LLM 406 and/or the second LLM 408 based on the user's selection of portions of the response. As an example, the method 400 may include a modified session/chat history 418 from the first LLM to include the paragraph 1.1 412a from the response from initial query 410a from the first LLM, an edited paragraph 1.2 420, and erasing portions of the LLM history 422 as a new prompt 424. Optionally, in some examples, the method 400 may include combining the modified session/chat history 418 from the first LLM 406 with modified session/chat history 418 from the second LLM 408 including paragraph 2.3 516c as a new prompt 424.

The new prompt 424 will include at least the modified session/chat history 418 for input into the third LLM 426. In some aspects, the new prompt 424 will include the initial query 402, the standard prompt 404a, and the response from the initial query 410a from the first LLM.

In this way, the method 400 may highlight important sections can help the LLM focus on key information, improving the relevance and accuracy of responses to related queries. This allows the LLM to ignore irrelevant details and streaming the response generation process. In addition, editing sections of a query response can clarify or correct information, leading to more precise and accurate responses in future interactions. In some aspects, removing sections or portions of the query response can prevent the LLM from considering outdated or incorrect information, which can enhance the quality of responses. By modifying the chat history, you effectively guide the LLM to adapt its understanding and focus, which can be particularly useful in iterative tasks or ongoing projects. In addition, if the modified history is shared with other LLMs, these LLM models can also benefit from the curated context, potentially leading to more consistent and relevant responses across different platforms. Finally, modifying a chat/session history can help the LLM system better understand user intent by emphasizing what the user considers important, thus tailoring responses more closely to user needs.

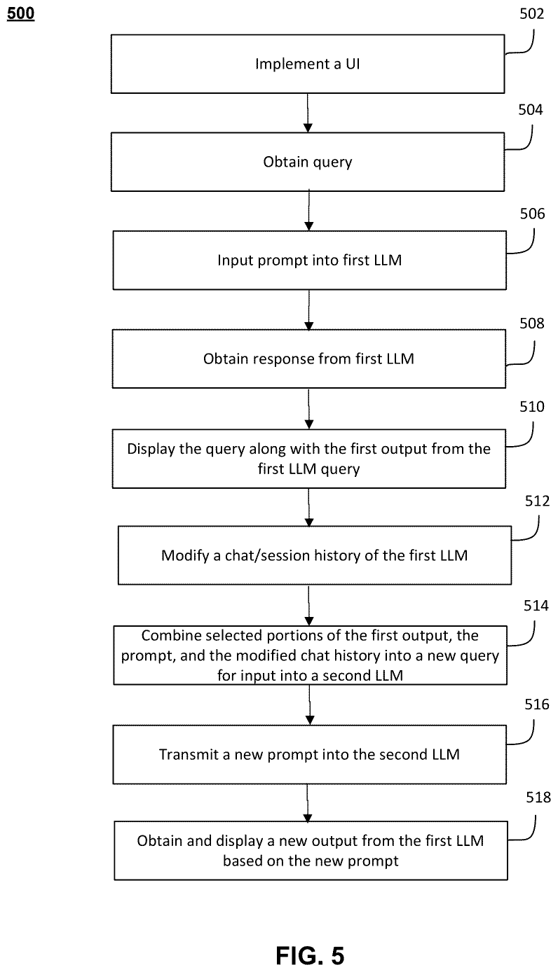

FIG. 5 is an example method 500 for improving a response of a LLM based on feedback from a user using a single LLM according to an aspect of the present disclosure. In various implementations, the method 500 is performed by a device with one or more processors and non-transitory memory that performs intent prediction. In some implementations, the method 500 is performed by processing logic, including hardware, firmware, software, or a combination thereof. In some implementations, the method 500 is performed by a processor executing code stored in a non-transitory computer-readable medium (e.g., a memory). The method 500 describes a method for providing a UI to improve responses from a single LLM.

At 502, the method 400 includes implementing a UI configured to combine and provide feedback from at least two LLMs by displaying responses from the at least two LLMs. As an example, referring back to FIG. 1, the UI generation module 112 may be configured to implement and generate a UI for display on a display of a computing device 104. As another example, referring back to FIG. 3A, the UI 202 may display a first response 304b from a first LLM 304a and a second response 306b from a second LLM 306a.

At 504, the method 500 includes obtaining a prompt (or query) from a user from an input portion of the user interface. As an example, referring back to FIG. 1, the query module 114 may be configured to obtain a query from the user and generate a prompt to input into a LLM. As another example, referring back to FIG. 3A, the UI 302 has an input portion 310 configured to obtain a query from a user.

At 506, the method 500 includes inputting a prompt into a first LLM and a second LLM. As an example, referring back to FIG. 1, the query module 114 may work in conjunction with the LLM communication module 116 to transmit the prompt into a first LLM connected to a LLM service provider #1 132.

At 508, the method 500 includes obtaining a response from the first LLM. As an example referring back to FIG. 1, the LLM communication module 116 may work in conjunction with the results analyzer module 12—to obtain a response from the first LM via the LLM service provider #1 132.

At 510, the method 500 includes displaying the query along with the first response from the first LLM in a first portion of the UI. As an example, referring back to FIG. 1, the display module may display the query along with the first response from the first LLM in a first portion of the UI. As another example, referring back to FIG. 2A, the UI 202 displays the response 204b from the first LLM 204a along with the original prompt 204.

At 512, the method 500 includes modifying a chat history of the first LLM based on obtaining a selection of at least one portion of the first response from the first LLM. As an example, referring back to FIG. 4, a user may select particular portions of a response from the initial query 410a from first LLM to modify the session/chat history from the first LLM to include the paragraph 1.1 412a, an edited paragraph 1.2 420, and “erased parts” in LLM history 422 to generate a new prompt 424.

At 514, the method 400 includes combining selected portions of the first response from the first LLM, the prompt, and the modified chat history into a new prompt for input into a second LLM. The second LLM is different from the first LLM. As an example, referring back to FIG. 1, the results analyzer module 120 may work in conjunction with the LLM communication module 116 and the query module 114 to combine selected portions of the first response from the first LLM into a new prompt for input into a second LLM connected to the LLM service provider #2 134.

In some examples, the combined portions of the first response are selected based on being marked as important. As an example, referring back to FIG. 2B, a user may highlight a selected portion 208 of the response as being important.

At 516, the method 500 includes transmitting the new prompt for input into the second LLM. As an example, referring back to FIG. 1, the query module 114 may work in conjunction with the LLM communication module 116 to generate and transmit the new prompt for input into the second LLM connected to the LLM service provider #2 134.

At 518, the method 500 includes obtaining and displaying a new response from the second LLM based on the new prompt. As an example, referring back to FIG. 1, the LLM communication module 116 will work in conjunction with the results analyzer module 120 and the display module 122 to obtain and display the new response from the second LLM connected to the LLM service provider #2 134 at a display of the computing device 104. As another example, referring back to FIG. 2E, the UI 202 displays a new response 205b from the second LLM 205a and a first response 204b from a first LLM 204a along with the new prompt 216. As yet another example, referring back to FIG. 3B, the UI 302 may display a new response 322b from a third LLM 322a based on a new prompt.

In some aspects, the method 500 may include displaying, in the UI, a supplemental UI comprising a menu of text editing functions for editing the query, the first response, or the new response.

In some aspects, the method 500 may include displaying, in the UI, a first graphical element configured to mark a response as important, not important, or to be deleted from chat history. As an example, referring back to FIG. 3A, the UI 302 may display a graphical element to mark a response as important 316 or not important 318.

In some aspects, the method 500 may include displaying, in the UI, a second graphical element configured to save at least one response. As an example, referring back to FIG. 3A, the UI 302 may display a fifth graphical element for saving the query and/or response 320.

In some aspects, the method 500 may include displaying, in the UI, a drop down graphical element with options including at least: a first option to edit the query, a second option to save the query, a third option to mark a portion of the first response or the new response as important, a fourth option to mark a portion of the first response or the new response as unimportant, a fifth option to mark a portion of the first response or the new response as unimportant, or a sixth option to edit the first response from the first LLM or the second response from the second LLM. As an example, referring back to FIG. 2B-C, the UI 202 may include a drop down menu 206 including at least: a first option to edit the query, a second option to save the query, a third option to mark a portion of the first response or the new response as important, a fourth option to mark a portion of the first response or the new response as unimportant, a fifth option to mark a portion of the first response or the new response as unimportant, or a sixth option to edit the first response from the first LLM or the second response from the second LLM.

In some aspects, the method 500 may include displaying a first metadata information corresponding to the first LLM and second metadata information corresponding to the second LLM in the UI.

In some aspects, the method 500 may include: obtaining a selection of at least a portion of the first response in the first portion of the UI for copying into an input area in the UI; inputting the selection of the at least a portion of the first response into the input area of the UI to transmitting as an updated query to the second LLM; transmitting the updated query for input into the second LLM; obtaining an updated second response from the second LLM; and displaying the updated query along with the updated second response from the second LLM in the second portion of the UI.

In some aspects, the method 500 may include: transmitting a request to an application programming interface (API) for the first LLM with the query, wherein the API processes the query by routing the query to the first LLM for processing the query and generating the first response; obtaining the first response of the first LLM for display in the first portion of the UI; transmitting a request to an API for the second LLM with the query, wherein the API processes the query by routing the query to the second LLM for processing the query and generating a second response; and obtaining the second response of the second LLM for display in the second portion of the UI.

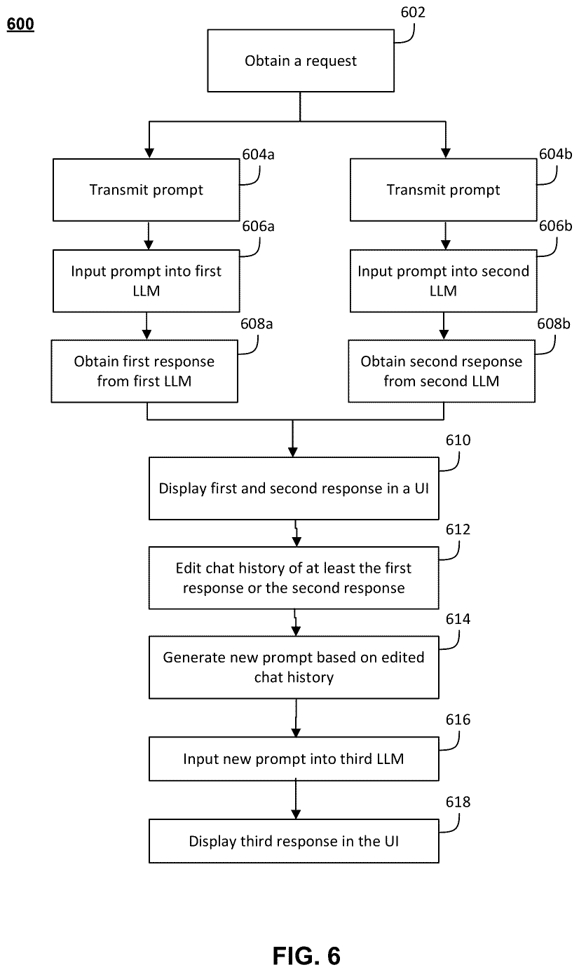

FIG. 6 is an example method for improving a response of LLMs based on feedback from a user using multiple LLMs according to an aspect of the present disclosure. In various implementations, the method 600 is performed by a device with one or more processors and non-transitory memory that performs intent prediction. In some implementations, the method 600 is performed by processing logic, including hardware, firmware, software, or a combination thereof. In some implementations, the method 600 is performed by a processor executing code stored in a non-transitory computer-readable medium (e.g., a memory). The method 600 describes a method for providing a UI to improve responses from a single LLM based on editing chat history of at least one LLM.

At 602, the method 600 includes obtaining a request (or query) from a user.

At 604a, the method 600 includes transmitting a prompt to a first LLM. At 604b, the method 600 includes transmitting the prompt to a second LLM.

At 606a, the method 600 includes inputting the prompt into the first LLM. At 606b, the method 600 includes inputting the prompt into a second LLM.

At 608a, the method 600 includes obtaining a first response from the first LLM. At 608b, the method 600 includes displaying a first and second response in a UI. At 608b, the method 500 includes obtaining a second response from the second LLM

At 610, the method 600 includes displaying a first and second response in a UI. As an example, referring back to FIG. 3A, the UI 302 displays a first response 304b from a first LLM 304a and a second response 306b from a second LLM 306a.

At 612, the method 600 includes editing a chat history of at least a first response from the first LLM or a second response from second LLM. As an example, referring back to FIG. 4, the method 400 includes modifying session/chat history 518 from responses of the LLMs.

At 614, the method 600 includes generating a new prompt based on the edited chat history, the first response, and the second response into a third LLM in the UI. As an example, referring back to FIG. 3A, a user may select a second graphical element for generating a new prompt 314 to combine the first response 304b from the first LLM 304a and the second response 306b from the second LLM 306a into a new prompt from a third LLM.

At 616, the method 600 includes inputting the combined response into the third LLM.

At 618, the method 600 includes displaying the third response in the UI. As an example, referring back to FIG. 3B, the UI 302 displays a third response 322b form the third LLM 322a.

FIG. 7 is a block diagram illustrating a computer system 20 on which aspects of systems and methods for synchronizing race telemetry, video, and map data may be implemented. The computer system 20 can be in the form of multiple computing devices, or in the form of a single computing device, for example, a desktop computer, a notebook computer, a laptop computer, a mobile computing device, a smart phone, a tablet computer, a server, a mainframe, an embedded device, and other forms of computing devices.

As shown, the computer system 20 includes a central processing unit (CPU) 21, a system memory 22, and a system bus 23 connecting the various system components, including the memory associated with the central processing unit 21. The system bus 23 may comprise a bus memory or bus memory controller, a peripheral bus, and a local bus that is able to interact with any other bus architecture. Examples of the buses may include PCI, ISA, PCI-Express, HyperTransport™, InfiniBand™, Serial ATA, I²C, and other suitable interconnects. The central processing unit 21 (also referred to as a processor) can include a single or multiple sets of processors having single or multiple cores. The processor 21 may execute one or more computer-executable code implementing the techniques of the present disclosure. For example, any of commands/steps discussed in FIGS. 1-7 may be performed by processor 21. The system memory 22 may be any memory for storing data used herein and/or computer programs that are executable by the processor 21. The system memory 22 may include volatile memory such as a random access memory (RAM) 25 and non-volatile memory such as a read only memory (ROM) 24, flash memory, etc., or any combination thereof. The basic input/output system (BIOS) 26 may store the basic procedures for transfer of information between elements of the computer system 20, such as those at the time of loading the operating system with the use of the ROM 24.

The computer system 20 may include one or more storage devices such as one or more removable storage devices 27, one or more non-removable storage devices 28, or a combination thereof. The one or more removable storage devices 27 and non-removable storage devices 28 are connected to the system bus 23 via a storage interface 32. In an aspect, the storage devices and the corresponding computer-readable storage media are power-independent modules for the storage of computer instructions, data structures, program modules, and other data of the computer system 20. The system memory 22, removable storage devices 27, and non-removable storage devices 28 may use a variety of computer-readable storage media. Examples of computer-readable storage media include machine memory such as cache, SRAM, DRAM, zero capacitor RAM, twin transistor RAM, eDRAM, EDO RAM, DDR RAM, EEPROM, NRAM, RRAM, SONOS, PRAM; flash memory or other memory technology such as in solid state drives (SSDs) or flash drives; magnetic cassettes, magnetic tape, and magnetic disk storage such as in hard disk drives or floppy disks; optical storage such as in compact disks (CD-ROM) or digital versatile disks (DVDs); and any other medium which may be used to store the desired data and which can be accessed by the computer system 20.

The system memory 22, removable storage devices 27, and non-removable storage devices 28 of the computer system 20 may be used to store an operating system 35, additional program applications 37, other program modules 38, and program data 39. The computer system 20 may include a peripheral interface 46 for communicating data from input devices 40, such as a keyboard, mouse, stylus, game controller, voice input device, touch input device, or other peripheral devices, such as a printer or scanner via one or more I/O ports, such as a serial port, a parallel port, a universal serial bus (USB), or other peripheral interface. A display device 47 such as one or more monitors, projectors, or integrated display, may also be connected to the system bus 23 across an output interface 48, such as a video adapter. In addition to the display devices 47, the computer system 20 may be equipped with other peripheral output devices (not shown), such as loudspeakers and other audiovisual devices.

The computer system 20 may operate in a network environment, using a network connection to one or more remote computers 49. The remote computer (or computers) 49 may be local computer workstations or servers comprising most or all of the aforementioned elements in describing the nature of a computer system 20. Other devices may also be present in the computer network, such as, but not limited to, routers, network stations, peer devices or other network nodes. The computer system 20 may include one or more network interfaces 51 or network adapters for communicating with the remote computers 49 via one or more networks such as a local-area computer network (LAN) 50, a wide-area computer network (WAN), an intranet, and the Internet. Examples of the network interface 51 may include an Ethernet interface, a Frame Relay interface, SONET interface, and wireless interfaces.

Aspects of the present disclosure may be a system, a method, and/or a computer program product. The computer program product may include a computer readable storage medium (or media) having computer readable program instructions thereon for causing a processor to carry out aspects of the present disclosure.

The computer readable storage medium can be a tangible device that can retain and store program code in the form of instructions or data structures that can be accessed by a processor of a computing device, such as the computing system 20. The computer readable storage medium may be an electronic storage device, a magnetic storage device, an optical storage device, an electromagnetic storage device, a semiconductor storage device, or any suitable combination thereof. By way of example, such computer-readable storage medium can comprise a random access memory (RAM), a read-only memory (ROM), EEPROM, a portable compact disc read-only memory (CD-ROM), a digital versatile disk (DVD), flash memory, a hard disk, a portable computer diskette, a memory stick, a floppy disk, or even a mechanically encoded device such as punch-cards or raised structures in a groove having instructions recorded thereon. As used herein, a computer readable storage medium is not to be construed as being transitory signals per se, such as radio waves or other freely propagating electromagnetic waves, electromagnetic waves propagating through a waveguide or transmission media, or electrical signals transmitted through a wire.

Computer readable program instructions described herein can be downloaded to respective computing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network interface in each computing device receives computer readable program instructions from the network and forwards the computer readable program instructions for storage in a computer readable storage medium within the respective computing device.

Computer readable program instructions for carrying out operations of the present disclosure may be assembly instructions, instruction-set-architecture (ISA) instructions, machine instructions, machine dependent instructions, microcode, firmware instructions, state-setting data, or either source code or object code written in any combination of one or more programming languages, including an object oriented programming language, and conventional procedural programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a LAN or WAN, or the connection may be made to an external computer (for example, through the Internet). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present disclosure.

In various aspects, the systems and methods described in the present disclosure can be addressed in terms of modules. The term “module” as used herein refers to a real-world device, component, or arrangement of components implemented using hardware, such as by an application specific integrated circuit (ASIC) or FPGA, for example, or as a combination of hardware and software, such as by a microprocessor system and a set of instructions to implement the module's functionality, which (while being executed) transform the microprocessor system into a special-purpose device. A module may also be implemented as a combination of the two, with certain functions facilitated by hardware alone, and other functions facilitated by a combination of hardware and software. In certain implementations, at least a portion, and in some cases, all, of a module may be executed on the processor of a computer system. Accordingly, each module may be realized in a variety of suitable configurations, and should not be limited to any particular implementation exemplified herein.

In the interest of clarity, not all of the routine features of the aspects are disclosed herein. It would be appreciated that in the development of any actual implementation of the present disclosure, numerous implementation-specific decisions must be made in order to achieve the developer's specific goals, and these specific goals will vary for different implementations and different developers. It is understood that such a development effort might be complex and time-consuming, but would nevertheless be a routine undertaking of engineering for those of ordinary skill in the art, having the benefit of this disclosure.

Furthermore, it is to be understood that the phraseology or terminology used herein is for the purpose of description and not of restriction, such that the terminology or phraseology of the present specification is to be interpreted by the skilled in the art in light of the teachings and guidance presented herein, in combination with the knowledge of those skilled in the relevant art(s). Moreover, it is not intended for any term in the specification or claims to be ascribed an uncommon or special meaning unless explicitly set forth as such.

The various aspects disclosed herein encompass present and future known equivalents to the known modules referred to herein by way of illustration. Moreover, while aspects and applications have been shown and described, it would be apparent to those skilled in the art having the benefit of this disclosure that many more modifications than mentioned above are possible without departing from the inventive concepts disclosed herein.

What is claimed is:

1. A method for providing a user interface (UI) to improve responses from large language models (LLMs) by modifying chat history of at least one LLM, the method comprising:
implementing a UI configured to combine and provide feedback from at least two LLMs by displaying responses from the at least two LLMs;
obtaining a query from a user from an input portion of the UI;
transmitting a prompt based on the query for input into a first LLM and a second LLM;
obtaining at least a first response from the first LLM;
displaying the query along with the first response from the first LLM in a first portion of the UI;
modifying a chat history of the first LLM based on obtaining a selection of at least one portion of the first response from the first LLM;
combining the selected portions of the first response from the first LLM, the prompt, and the modified chat history into a new prompt for input into the second LLM, wherein the first LLM is different from the second LLM;
transmitting the new prompt for input into the second LLM; and
obtaining and displaying a new response from the second LLM based on the new prompt in a second portion of the UI.

2. The method of claim 1, wherein the combined portions of the first response are selected based on being modified, marked as important, not important, or to be deleted from the chat history.

3. The method of claim 1, further comprising:
transmitting the new prompt into the at least two or more LLMs;
obtaining at least a first response from the first LLM and a second response from the second LLM; and
displaying the query along with the first response from the first LLM in the first portion of the UI and the second response from the second LLM in the second portion of the UI.

4. The method of claim 3, further comprising:
combining parts of the first response from the first LLM and parts of the second response from the second LLM into a new query;
transmitting the new query into one of the least two or more LLMs; and
displaying the new query along with a third response from the one of the least two or more LLMs in a third portion of the UI.

5. The method of claim 1, further comprising:
displaying, in the UI, a supplemental UI comprising a menu of text editing functions for editing the query, the first response or the new response.

6. The method of claim 1, further comprising:
displaying, in the UI, a first graphical element configured to mark a response as important, not important, or to be deleted.

7. The method of claim 1, further comprising:
displaying, in the UI, a second graphical element configured to save at least one response.

8. The method of claim 1, further comprising:
displaying, in the UI, a drop down graphical element with options including at least: a first option to edit the query, a second option to save the query, a third option to mark a portion of the first response or the new response as important, a fourth option to mark a portion of the first response or the new response as unimportant, a fifth option to mark a portion of the first response or the new response as to be deleted, or a sixth option to edit the first response from the first LLM or the second response from the second LLM.

9. The method of claim 1, further comprising:
displaying a first metadata information corresponding to the first LLM and second metadata information corresponding to the second LLM in the UI.

10. The method of claim 1, further comprising:
obtaining a selection of at least a portion of the first response in the first portion of the UI for copying into an input area in the UI;
inputting the selection of the at least a portion of the first response into the input area of the UI to transmitting as an updated query to the second LLM;
transmitting the updated query for input into the second LLM;
obtaining an updated second response from the second LLM; and
displaying the updated query along with the updated second response from the second LLM in the second portion of the UI.

11. The method of claim 1, further comprising:
transmitting a request to an application programming interface (API) for the first LLM with the query, wherein the API processes the query by routing the query to the first LLM for processing the query and generating the first response;
obtaining the first response of the first LLM for display in the first portion of the UI;
transmitting a request to an API for the second LLM with the query, wherein the API processes the query by routing the query to the second LLM for processing the query and generating a second response; and
obtaining the second response of the second LLM for display in the second portion of the UI.

12. A system for providing a user interface (UI) to provide a user interface (UI) to improve responses from large language models (LLMs) by modifying chat history of at least one LLM, the system comprising:
at least one memory; and
at least one hardware processor coupled with the at least one memory and configured, individually or in combination, to:
implement a UI configured to combine and provide feedback from at least two LLMs by displaying responses from the at least two LLMs;
obtain a query from a user from an input portion of the UI;
transmit a prompt based on the query for input into a first LLM and a second LLM;
obtain at least a first response from the first LLM;
cause, on a display, a display of the query along with the first response from the first LLM in a first portion of the UI;
modify a chat history of the first LLM based on obtaining a selection of at least one portion of the first response from the first LLM;
combine the selected portions of the first response from the first LLM, the prompt, and the modified chat history into a new prompt for input into the second LLM, wherein the first LLM is different from the second LLM;
transmit the new prompt for input into the second LLM; and
obtain and cause, on the display, a display of a new response from the second LLM based on the new prompt in a second portion of the UI.

13. The system of claim 12, wherein the combined portions of the first response are selected based on being modified, marked as important, not important, or to be deleted from the modified chat history.

14. The system of claim 12, wherein the at least one hardware processor coupled with the at least one memory and is further configured, individually or in combination, to:
transmit the new prompt into the at least two or more LLMs;
obtain at least a first response from the first LLM and a second response from the second LLM; and
cause, on the display, a display of the query along with the first response from the first LLM in the first portion of the UI and the second response from the second LLM in the second portion of the UI.
cause, on the display, a display of the query along with the first response from the first LLM in the first portion of the UI and the second response from the second LLM in the second portion of the UI.

15. The system of claim 14, wherein the at least one hardware processor coupled with the at least one memory and is further configured, individually or in combination, to:
combine parts of the first response from the first LLM and parts of the second response from the second LLM into a new query;
transmit the new query into one of the least two or more LLMs; and
cause, on the display, a display of the new query along with a third response from the one of the least two or more LLMs in a third portion of the UI.

16. The system of claim 12, wherein the at least one hardware processor coupled with the at least one memory and is further configured, individually or in combination, to:
cause, on the display, a display, in the UI, of a supplemental UI comprising a menu of text editing functions for editing the query, the first response or the new response.

17. The system of claim 12, wherein the at least one hardware processor coupled with the at least one memory and is further configured, individually or in combination, to:
cause, on the display, a display, in the UI, of a first graphical element configured to mark a response as important, not important, or to be deleted.

18. The system of claim 12, wherein the at least one hardware processor coupled with the at least one memory and is further configured, individually or in combination, to:
cause, on the display, a display, in the UI, of a second graphical element configured to save at least one response.

19. The system of claim 12, wherein the at least one hardware processor coupled with the at least one memory and is further configured, individually or in combination, to:
cause, on the display, a display, in the UI, of a first metadata information corresponding to the first LLM and second metadata information corresponding to the second LLM in the UI.

20. A method for improving responses from large language models (LLMs) by modifying chat history of at least one LLM, the method comprising:
obtaining a query from a user;
transmitting a prompt based on the query for input into a first LLM and a second LLM;
obtaining at least a first response from the first LLM;
modifying a chat history of the first LLM based on obtaining a selection of at least one portion of the first response from the first LLM;
combining the selected portions of the first response from the first LLM, the prompt, and the modified chat history into a new prompt for input into the second LLM, wherein the first LLM is different from the second LLM;
transmitting the new prompt for input into the second LLM; and
obtaining and displaying a new response from the second LLM based on the new prompt.
